(19) United States
(12) Patent Application Publication
(10) Pub. No.: US 2005/0136846 A1
(43) Pub. Date: Jun. 23, 2005

(54) RF transceiver

(75) Inventors: Jae-Hyoung Kim, Anyang-si (KR); Young-Il Son, Suwon-si (KR); Dae-Hyun Sim, Seoul (KR); Sang-Kook Han, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 11/006,138

(22) Filed: Dec. 7, 2004

(30) Foreign Application Priority Data
Dec. 23, 2003 (KR) 95463/2003

(51) Int. Cl. H04B 1/44

(52) U.S. Cl. 455/78; 455/41.2

(57) ABSTRACT

Disclosed is an RF transceiver including a receiver chain performing a dual conversion with respect to a received RF signal, thereby generating an IF signal; a chain of transceiver performing a dual conversion with respect to an IF signal to be transmitted, thereby generating an RF signal; and an IF SAW filter used in the receiver chain and the transmitter chain in common, the IF SAW removing an unnecessary signal generated during a first down-conversion after an IF signal having undergone the first down-conversion is IF-amplified in the receiver chain, and removing an unnecessary signal generated during a first up-conversion after an IF signal having undergone the first up-conversion is IF-amplified in the transmitter chain.

### PRIORITY

This application claims priority to an application entitled “RF Transceiver” filed in the Korean Intellectual Office on Dec. 23, 2003 and assigned Ser. No. 2003-95463, the contents of which are hereby incorporated by reference.

### BACKGROUND OF THE INVENTION

1. Field of the Invention

The present invention relates to a user terminal that operates according to IEEE Standard 802.16e, and more particularly to an RF transceiver of a user terminal.

2. Description of the Related Art

Recently, the IEEE 802.16e Standard for supporting mobility of vehicles with a technique similar to a portable internet technique has been actively developed. The IEEE 802.16e Standard is planned to be an extension to the 802.16a Standard which is a standard for fixed broadband wireless access using a frequency band of 2 to 11 GHz. While IEEE 802.16a does not support mobility, IEEE 802.16e supports a handoff function between base stations, a roaming function, and mobility of vehicles, similarly to GSM (Global System for Mobile Communications), GPRS (General Packet Radio Service), and CDMA (Code Division Multiple Access). The IEEE 802.16e Standard is expected to be used for providing backhaul or internet access service, centered around a large city or a specific service area having a large number of subscribers.

Therefore, a need exists for a Radio Frequency (RF) transceiver which is suitable to operate in a time division duplex (TDD) mode prescribed by the IEEE 802.16e Standard.

### SUMMARY OF THE INVENTION

Accordingly, the present invention has been made to solve the above-mentioned shortcomings of conventional systems, and an object of the present invention is to provide an RF transceiver which is suitable to operate in a time division duplex (TDD) mode prescribed by the IEEE 802.16e Standard.

To accomplish this object, in accordance with one aspect of the present invention, there is provided an RF transceiver that includes a receiver chain performing a dual conversion with respect to a received RF signal, thereby generating an Intermediate Frequency (IF) signal; a transmitter chain performing a dual conversion with respect to an IF signal to be transmitted, thereby generating an RF signal; and an IF SAW filter commonly used in the receiver chain and the transmitter chain, the IF SAW removing an unnecessary signal generated during a first down-conversion after an IF signal having undergone the first down-conversion is IF-amplified in the receiver chain, and removing an unnecessary signal generated during a first up-conversion after an IF signal having undergone the first up-conversion is IF-amplified in the transmitter chain.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing a construction of an RF transceiver of a user terminal according to the first embodiment of the present invention;

FIG. 2 is a table showing RF details of the respective components of the receiver chain in the RF transceiver according to the first embodiment of the present invention;

FIG. 3 is a table showing theoretically calculated property values of the entire receiver chain;

FIG. 4 is a table showing RF details of the respective components of the transmitter chain in the RF transceiver according to the first embodiment of the present invention;

FIG. 5 is a table showing theoretically calculated property values of the entire transmitter chain;

FIG. 6 is a block diagram showing a construction of an RF transceiver according to a second embodiment of the present invention;

FIG. 7 is a table showing the characteristic of the entire receiver chain in the RF transceiver according to the second embodiment of the present invention; and

FIG. 8 is a table showing the characteristic of the entire transmitter chain in the RF transceiver according to the second embodiment of the present invention.

### DETAILED DESCRIPTION OF THE PREFERRED EMBODIMENTS

Hereinafter, preferred embodiments of an RF transceiver according to the present invention will be described with reference to the accompanying drawings. In the following description of the present invention, a detailed description of known functions and configurations incorporated herein will be omitted to avoid making the subject matter of the present invention unclear.

An RF transceiver using a TDD (Time Division Duplex) mode according to the IEEE 802.16e Standard employs a digital IF method. Therefore, in order to generate a final IF to be inputted from the RF transceiver to a modem, it is necessary to define a method for converting an RF signal received from a base station into an IF signal.

In the present invention, a double conversion mode is utilized as a method for converting an RF signal into an IF signal. According to the double conversion mode, an RF transceiver converts an RF signal into a first IF signal, and then converts the first IF signal into a second IF signal to be inputted to the modem. In the RF transceiver according to the present invention, frequency conversion is performed two times with respect to each down-conversion and up-conversion, and an IF SAW filter of the RF transceiver employed for IF signals is commonly used for both reception and transmission. A construction and an operation of an RF transmitter of a user terminal according to a first embodiment of the present invention will be described.

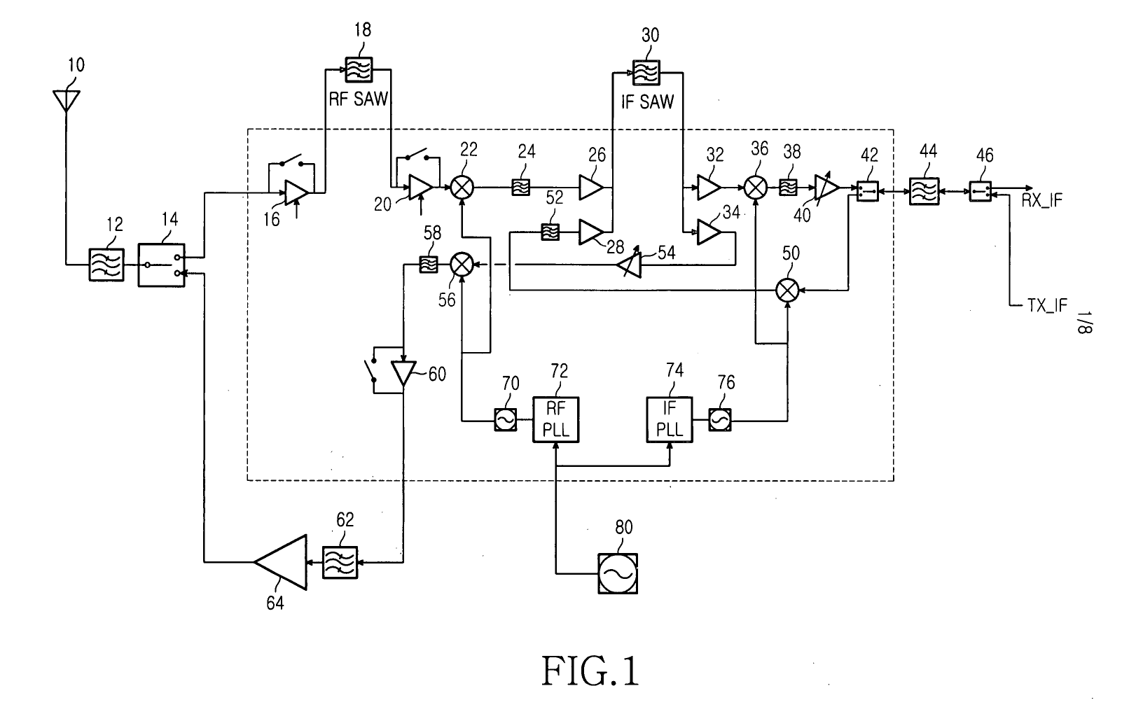

FIG. 1 is a block diagram showing a construction of an RF transceiver of a user terminal according to the first embodiment of the present invention. As shown in FIG. 1, the RF transceiver is a transmitting/receiving device whose transmitter chain and receiver chain are combined as a package using a TDD (Time Division Duplex) mode. According to the TDD mode, a transmitting operation is off when a receiving operation is on, and the receiving operation is off when the transmitting operation is on, providing an advantage of reduced power consumption, as compared with a CDMA mode, which simultaneously performs a receiving operation and a transmitting operation. In the present invention, a power source is used for the receiver chain and the transmitter chain so that the RF transceiver may be operated as a desired part of the receiver chain and the transmitter chain.

Referring to FIG. 1, according to the first embodiment of the present invention, the RF transceiver includes a receiver chain for receiving an RF signal and a transmitter chain for transmitting an RF signal, in which the receiver chain and the transmitter chain are combined as a package. Therefore, the receiver chain and the transmitter chain according to the present invention have a few components in common, as described below in detail. The RF transceiver transmits and receives an RF signal through an antenna 10. In the following description, the receiver chain in the RF transceiver will be described first.

The receiver chain includes a common RF SAW filter 12, an antenna switch 14, a first low-noise amplifier (LNA) 16, a receiving RF SAW filter 18, a second low-noise amplifier 20, a first receiving mixer 22, a first receiving band-pass filter (BPF) 24, a first receiving IF amplifier 26, an IF SAW filter 30, a second receiving IF amplifier 32, a second receiving mixer 36, a second receiving band-pass filter 38, a receiving automatic gain control amplifier (hereinafter referred to as an ‘Rx AGC amplifier’) 40, an RTX (Real Time Executive) switches 42 and 46, and a common RF SAW filter 44. The signal flow in such a receiver chain will now described.

An RF signal transmitted from a base station is received by antenna 10 of the RF transceiver. The RF signal received by the antenna 10 is transmitted to the antenna switch 14 through the common RF SAW filter 12. In a reception mode, the antenna switch 14 is controlled to connect the common RF SAW filter 12 to the first low-noise amplifier 16. Therefore, the RF signal received in a reception mode is inputted into the first low-noise amplifier 16 through the antenna switch 14, and is thus amplified. An RF signal transmitted from the first low-noise amplifier 16 is inputted into the second low-noise amplifier 20 through the receiving RF SAW filter 18. The first and second low-noise amplifiers 16 and 20 determine a noise level of an RF signal inputted through the antenna, thereby minimizing the power of the noise generated when the RF signal is amplified. The first and second low-noise amplifiers 16 and 20 utilize on/off signals, which are outputted from the modem (not shown), as control signals. That is, operations of the first and second low-noise amplifiers 16 and 20 is turned on or off by these control signals.

Subsequently, an RF signal transmitted from the second low-noise amplifier 20 is inputted into the first receiving mixer 22. The first receiving mixer 22 mixes the RF signal outputted from the second low-noise amplifier 20 with a first local oscillation signal outputted from a first local oscillator 70, thereby generating a first receiving IF signal of 240 MHz. The first receiving IF signal is inputted into the IF SAW filter 30 via the first receiving band-pass filter 24 and the first receiving IF amplifier 26. The IF SAW filter 30 removes undesired noise from the signal generated in the first receiving mixer 22 from the IF signal down-converted in the first receiving mixer 22, and outputs the IF signal to the second receiving IF amplifier 32. Herein, the IF SAW filter 30 is commonly used in the receiver chain and the transmitter chain.

Subsequently, the first receiving IF signal is inputted into the second receiving mixer 36 via the second receiving IF amplifier 32. The second receiving mixer 36 mixes the first receiving IF signal with a second local oscillation signal outputted from a second local oscillator 76, thereby generating a second receiving IF signal, typically of 70 MHz, which is down-converted once more, and outputs the second receiving IF signal to the second receiving band-pass filter 38. Next, the second receiving IF signal is inputted into the Rx AGC amplifier 40 via the second receiving band-pass filter 38. Then, the second receiving IF signal passing through the Rx AGC amplifier 40 is inputted into the modem through the RTX switch 46.

That is, a signal received into the receiver chain passes a low-noise amplification unit including the first low-noise amplifier 16 and the second low-noise amplifier 20. An RF signal received by the antenna 10 and has passed the low-noise amplification unit passes the first receiving mixer 22, so as to be converted into a first IF signal of 240 MHz. The first IF signal passes the IF SAW filter 30 via the first receiving IF amplifier 26, and then passes the second receiving IF amplifier 32. The first IF signal of 240 MHz passes the second receiving mixer 36, so as to be converted into a second IF signal of 70 MHz, and then passes the Rx AGC amplifier 40. The Rx AGC amplifier 40 functions to maintain the power level of the 70 MHz second IF signal at a constant level of 0 dBm before outputting the second IF signal to the modem.

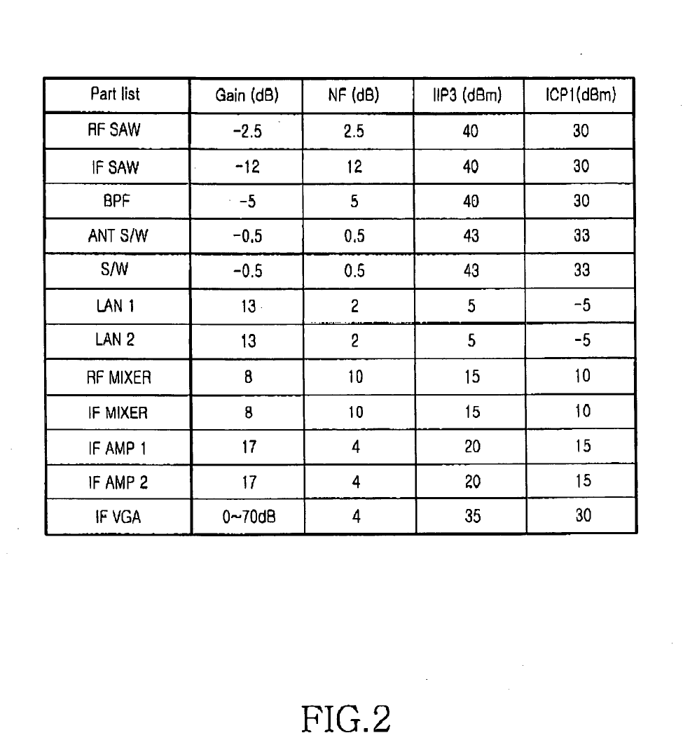

Specifications regarding the respective components of the receiver chain that were described above are shown in FIG. 2. FIG. 2 is a table showing RF details of the respective components of the receiver chain in the RF transceiver according to the first embodiment of the present invention. The detailed specifications of the respective components for constructing the receiver chain are provided in FIG. 2 to facilitate construction by those skilled in the art of the receiver chain of the RF transceiver shown in FIG. 1 using components having these specifications. In FIG. 2, NF (Noise Figure), IIP3 (3^{rd} Input Intercept Point) and ICP1 (Input Gain Compression Point) are as follows. NF is a ratio of input SNR to output SNR in a specific element, circuit or system. Since NF represents how much the noise increases through the element or circuit, a lower ratio is better. If an active element or circuit is amplified or converted, a heat noise can occur within the element and the noise can add to a signal passing through the element. NF can be used as an index to represent added noise and a numerical formula is NF=input SNR/output SNR. IIP3 is mainly used in regard to input characteristics of an LNA or Mixer, and represents power at a point where output power of an original signal is the same as that of a three dimensional IMD signal, with an index indicating linearity of an input party. IP3 generally relates to OIP3 and a numerical formula of “IIP3 =OIP3−gain” can be used. In regard to ICP1, a 1 dB Gain Compression Point is used to represent a maximum power point effectively available before reaching saturation. Input PidB indicates that input power at a point has decreased as much as 1 dB.

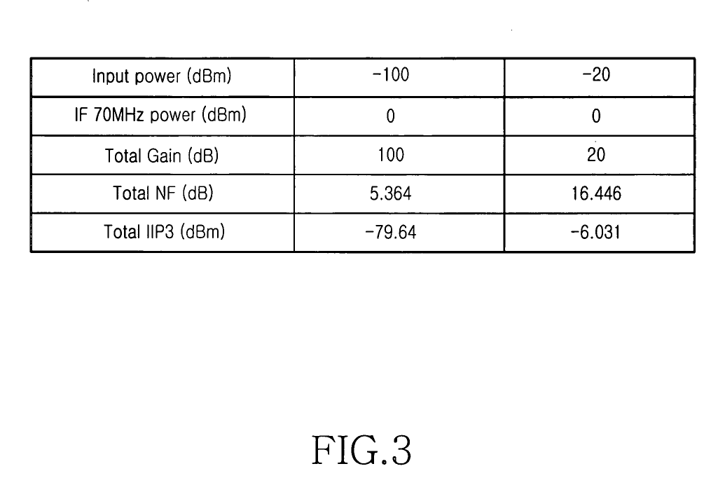

FIG. 3 is a table showing theoretically calculated property values of the entire receiver chain. An operating frequency of the RF transceiver proposed in the present invention has a range of 2.3 GHz to 2.4 GHz. In the receiver chain, the first receiving IF signal has a frequency of 240 MHz, and the second receiving IF signal has a frequency of 70 MHz. A reception power level is −100 to −20 dBm, and a transmission power level is −50 to +20 dBm. 70 MHz of the second receiving IF signal is an input frequency for an ADC (Analog to Digital Converter) of the modem, in which a power level of the 70 MHz signal is 0 dBm.

The transmitter chain shown if FIG. 1 is described below. The transmitter chain includes the RTX switch 42, a first transmitting mixer 50, a first transmitting band-pass filter (BPF) 52, a first transmitting IF amplifier 28, the IF SAW filter 30, a second transmitting IF amplifier 34, a transmitting AGC (hereinafter, referred to as a ‘Tx AGC amplifier’) 54, a second transmitting mixer 56, a second transmitting band-pass filter 58, a driving amplifier 60, an RF SAW filter 62, a power amplifier 64, the antenna switch 14, and the common RF SAW filter 12. A PLL section includes an RF PLL (Phase Loop Lock) 72, an IF PLL 74, an RF VCO (Voltage Controlled Oscillator) 70, and an IF VCO 76. A description will be given for the signal flow in the transmitter chain having such a construction.

A first IF transmitting signal of 70 MHz and 0 dBm is inputted to the transmitter chain of the RF transceiver from the DAC (Digital to Analog Converter) of the modem. The first transmitting IF signal is outputted to the first transmitting mixer 50 through the RTX switch 42. In a transmission mode, the RTX switch 42 is controlled to connect the first transmitting mixer 50 to the modem. The first transmitting mixer 50 mixes the first transmitting IF signal of 70 MHz, which has been outputted from the modem, with a second local oscillation signal outputted from a second local oscillator 76, thereby generating an up-converted second transmitting IF signal of 240 MHz. The second transmitting IF signal is inputted into the IF SAW filter 30 via the first transmitting band-pass filter (BPF) 52 and the first transmitting IF amplifier 28.

The IF SAW filter 30 removes undesired noise from the signal generated in the first transmitting mixer 50, from the IF signal up-converted by the first transmitting mixer 50, and outputs the IF signal to the second transmitting IF amplifier 34. The second transmitting IF signal is inputted into the Tx AGC amplifier 54 via the second transmitting IF amplifier 34. The Tx AGC amplifier 54 functions to control a transmission power capable of changing a Tx transmission power. The second transmitting IF signal passing through the Tx AGC amplifier 54 passes the second transmitting mixer 56, to be converted into an RF signal. The second transmitting mixer 56 mixes the second transmitting IF signal of 240 MHz with the first local oscillation signal outputted from the first local oscillator 70, thereby generating a transmitting RF signal which is up-converted once more. The transmitting RF signal is inputted into the RF SAW filter 62 via the second transmitting band-pass filter 58 and the driving amplifier 60. The driving amplifier 60 is controlled according to control signals of on/off which are outputted from the modem. Next, the transmitting RF signal passes the RF SAW filter 62 and the power amplifier 64, and then is transmitted through the antenna switch 14.

That is, in the transmitter chain, an IF signal of 70 MHz outputted from the modem is converted into an IF signal of 240 MHz, and then passes an IF amplifier, which has an impedance identical to that of an IF amplifier used in the receiver chain and provides a gain of 0 dBm. Herein, the 240 MHz IF SAW filter 30 is commonly used in the transmitter chain and the receiver chain. The IF signal of 240 MHz passes the Tx AGC amplifier 54, to be converted into an RF signal of 2.3 GHz to 2.4 GHz, and then passes the driving amplifier 60. Finally, the RF signal passes the power amplifier 64.

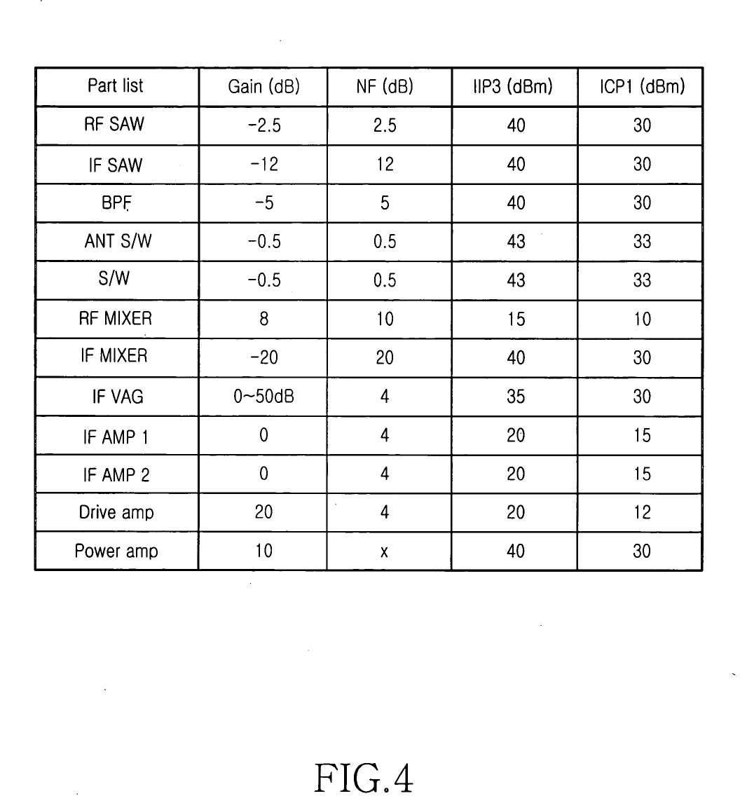

Specifications regarding the respective components of the transmitter chain that were described above are shown in FIG. 4. FIG. 4 is a table showing RF details of the respective components of the transmitter chain in the RF transceiver according to the first embodiment of the present invention. The detailed specifications of the respective components for constructing the transmitter chain are provided in FIG. 4 to facilitate construction by those skilled in the art of the transmitter chain of the RF transceiver shown in FIG. 1 using components having these specifications.

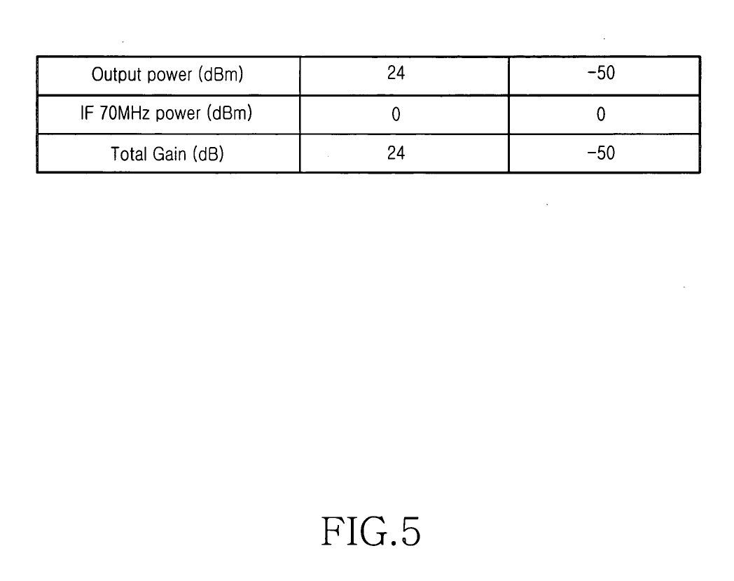

FIG. 5 is a table showing theoretically calculated property values of the entire transmitter chain. The first and the second receiving IF amplifier 26 and 32 of the receiver chain have the same construction as those of the first and the second transmitting IF amplifier 28 and 34 used in the transmitter chain, respectively, but provide different gains from the first and second transmitting IF amplifiers 28 and 34, respectively. A gain of the first and second receiving IF amplifiers 26 and 32 in the receiver chain is 17 dB, and a gain of the first and second transmitting IF amplifiers 28 and 34 in the transmitter chain is 0 dBm. Amplifiers having a same impedance are used in the receiver chain and the transmitter chain to provide an advantage of allowing the IF SAW filter 30 to be commonly used in the receiver chain and the transmitter chain without changing a matching value to match input and output impedances.

Specifications of the respective components shown in FIGS. 2 and 4 present values based on results obtained by block simulation using an ADS (Advanced Design System) tool commercially available from Agilent Technologies Inc. An RF transceiver according to the first embodiment has been described above, and an RF transceiver according to the second embodiment will be now described.

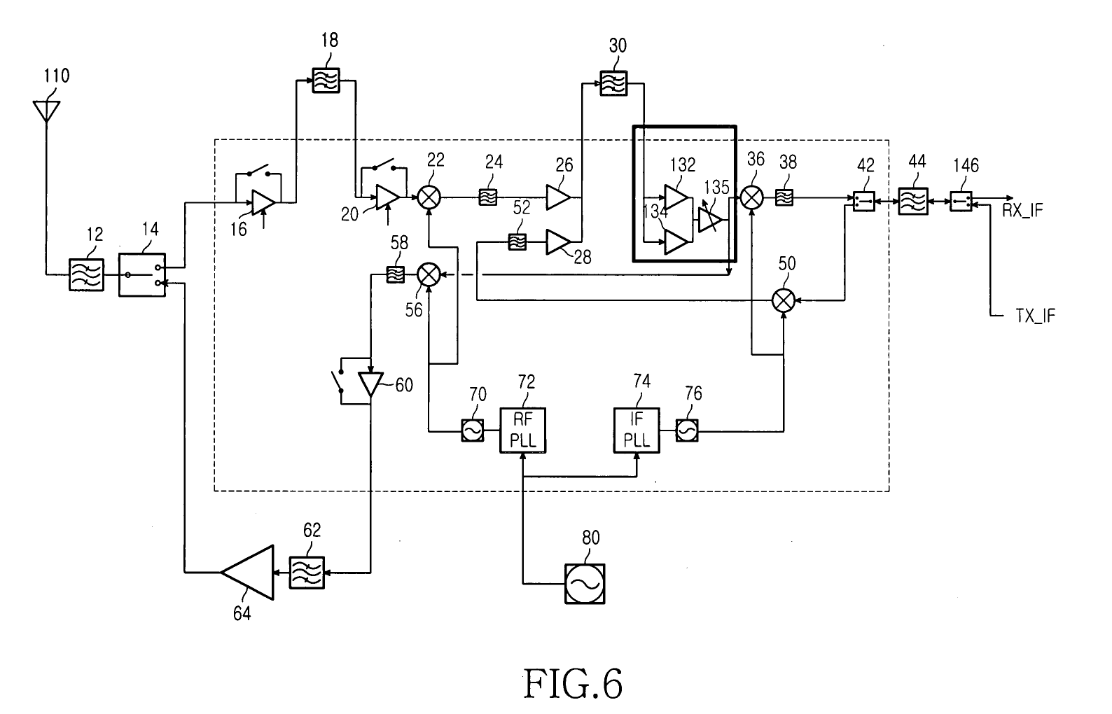

FIG. 6 is a block diagram showing a construction of an RF transceiver according to a second embodiment of the present invention. As shown in FIG. 6, the RF transceiver according to the second embodiment has a construction similar to that of the RF transceiver according to the first embodiment. A point of difference is that the RF transceiver of the second embodiment commonly uses the IF SAW filter 30 and an AGC amplifier 135 in a receiver chain and a transmitter chain of the RF transceiver.

As described above, since an RF transceiver of the present invention employs the TDD mode, a transmitting operation is off when a receiving operation is on, and the receiving operation is off when the transmitting operation is on. Therefore, if a component having a same construction and a same property is required in the receiver chain and the transmitter chain, it is possible to commonly use the component in the receiver chain and the transmitter chain.

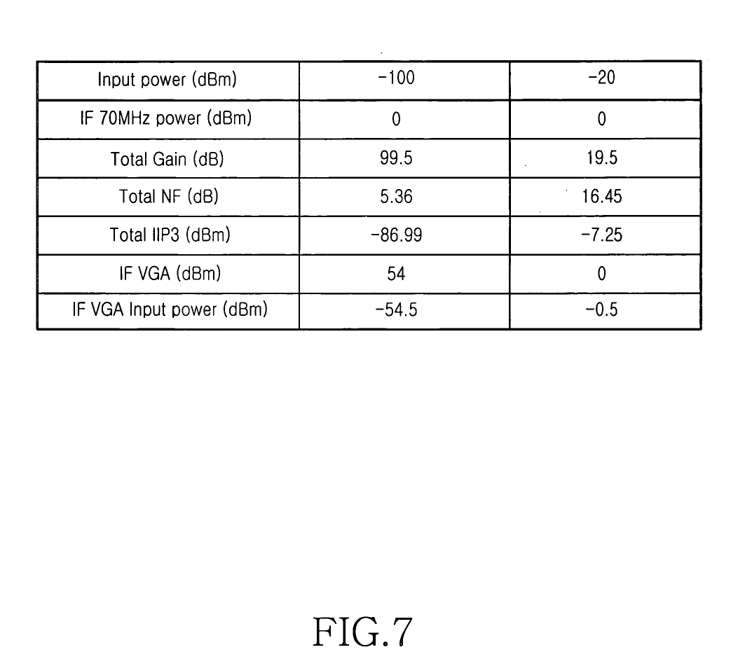

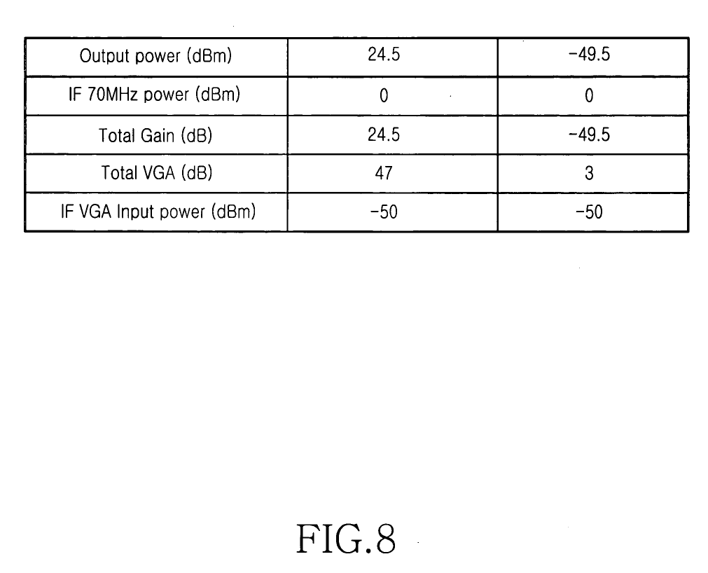

To this end, in the second embodiment of the present invention, output terminals of a second receiving IF amplifier 132 and a second transmitting IF amplifier 134 are connected to an input terminal of a common AGC amplifier 135. An output terminal of the common AGC amplifier 135 is connected to both the receiver chain and the transmitter chain. To be more specific, the common AGC amplifier 135 is connected to a second receiving mixer 36 in the receiver chain, and is also connected to a second transmitting mixer 56 in the transmitter chain. Therefore, the receiver chain and the transmitter chain can commonly use the IF SAW filter 30 as well as the common AGC amplifier 135. Specifications for the RF transceiver also having the common AGC amplifier 135 are shown in FIGS. 7 and 8.

FIG. 7 is a table showing the characteristic of the entire receiver chain in the RF transceiver according to the second embodiment of the present invention, and FIG. 8 is a table showing the characteristic of the entire transmitter chain in the RF transceiver according to the second embodiment of the present invention.

As shown in FIG. 7, an input power range of the receiving IF AGC amplifier is −54.5 dBm to −0.5 dBm, and a dynamic range of the receiving IF AGC amplifier is 54 dB to 0 dB. Also, as shown in FIG. 8, an input power of the transmitting IF AGC amplifier is −50 dBm, and a dynamic range of the transmitting IF AGC amplifier is 3 dB to 47 dB.

As shown in FIGS. 7 and 8, if a common AGC amplifier has an input power range of −54.5 dBm to −0.5 dBm and a dynamic range of 54 dB to 0 dB, the common AGC amplifier can be commonly used in the receiver chain and the transmitter chain. Since the dynamic range of the receiving IF AGC amplifier and the dynamic range of the transmitting IF AGC amplifier are similar to each other, it is possible to maintain a level of a modem control signal for controlling the dynamic range of the common IF AGC amplifier in a predetermined level.

As described above, the RF transceiver of the present invention is designed to be suitable for use in the TDD mode of the IEEE 802.16e standard. The RF transceiver according to the first embodiment is designed to commonly use an IF SAW filter in the receiver chain and the transmitter chain. Also, the RF transceiver according to the second embodiment is designed to commonly use not only an IF SAW filter but also an AGC amplifier in the receiver chain and the transmitter chain. Therefore, it is possible to reduce the number of IF SAW filters or/and AGC amplifiers used. In addition, since an IF amplifier in the receiver chain and an IF amplifier in the transmitter chain both have the same impedance, a same value can be used as matching values of IF SAW filters. Therefore, the RF transmitter according to the present invention has advantages of reduced manufacturing cost and reduce systems size.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

1. A Radio Frequency (RF) transceiver comprising:
a receiver chain for performing a dual conversion with respect to a received RF signal, for generating an Intermediate Frequency (IF) signal;
a transceiver chain for performing a dual conversion with respect to an IF signal, for generating an RF signal to be transmitted; and
an IF SAW filter commonly used in the receiver chain and in the transmitter chain to remove undesired noise generated during down-conversion after an IF signal having undergone the down-conversion is IF-amplified in the receiver chain or generated during up-conversion after an IF signal having undergone the up-conversion is IF-amplified in the transmitter chain.

2. The RF transceiver as claimed in claim 1, wherein a receiving IF amplifier for IF-amplifying the received RF signal in the receiver chain and a transmitting IF amplifier for IF-amplifying the signal to be RF transmitted in the transmitter chain both have a same impedance and have different gains.

3. The RF transceiver as claimed in claim 2, wherein the receiving IF amplifier in the receiver chain has a gain of 17 dB and the transmitting IF amplifier in the transmitter chain has a gain of 0 dB.

4. The RF transceiver as claimed in claim 1, wherein an automatic gain control amplifier is commonly used in the receiver chain and in the transmitter chain to control a reception power after the IF signal undergoes down-conversion and is IF-amplified in the receiver chain and to control a transmitting power after the IF signal undergoes up-conversion and is IF-amplified in the transmitter chain.

5. The RF transceiver as claimed in claim 4, wherein the automatic gain control amplifier has an input power range of −54.5 dBm to −0.5 dBm and a dynamic range of 54 dB to 0 dB.
